(19) United States
(12) Patent Application Publication
(10) Pub. No.: US 2026/0340200 A1
(43) Pub. Date: Oct. 29, 2026

(54) WHITE BOX ENCODING

(71) Applicant: BANKS AND ACQUIRERS INTERNATIONAL HOLDING, SURESNES (FR)

(72) Inventor: Vincent GIRAUD, PARIS (FR)

(21) Appl. No.: 19/121,487

(22) PCT Filed: Oct. 17, 2023
(86) PCT No.: PCT/EP2023/078864

§ 371 Date: Apr. 16, 2025

(30) Foreign Application Priority Data
Oct. 17, 2022 (FR) FR2210698

(51) Int. Cl. G06F 21/72; H04L 9/06

(52) U.S. Cl. CPC G06F 21/72; H04L 9/0625; H04L 9/0631

(57) ABSTRACT

An encoding generation method for a computer-implemented cryptographic algorithm. The method includes steps of obtaining at least one characteristic specific to a computer peripheral configured to execute a cryptographic algorithm, generating a dependent encoding operation of the peripheral on the basis of the specific characteristic, and associating the generated dependent encoding operation with the cryptographic algorithm.

### FIELD OF THE INVENTION

The invention relates to white-box cryptography and more particularly to the encoding operations associated with an encryption algorithm in the context of a white-box attack model.

### BACKGROUND

White-box cryptography is a study subject based on the postulate that an attacker, who tries to identify secret, encrypted data, that can be decrypted using an encryption algorithm, has full access to the algorithm execution platform and to the software implementation of this algorithm in the platform: the binary code is thus completely visible, it can be modified, and the attacker can also do whatever they wish regarding the software execution by means of the various systems of the platform such as the memory, calls to the processors, etc. The most traditional example is that of an attacker who has access to a smartphone belonging to a third party, in which a software application of the smartphone encrypts or decrypts secret data using an encryption key and a cryptographic algorithm, for example of the “AES” (“Advanced Encryption Standard”) type. The attacker has complete control over the smartphone and the algorithm, and can thus try to read the corresponding binary code, modify it, execute it specifically, with the final objective, knowing the type of algorithm used, of identifying the encryption key, decrypting the secret data, and/or modifying these data.

To prevent this attacker from accessing the secret data and to protect the integrity of the encryption in this white-box context, a method consisting in encoding elementary operations of the encryption (or decryption) algorithm is already known in the state of the art. In fact, an elementary operation, resulting from the combination between a known type of algorithm and a specific encryption key, is generally implemented as a truth table indicating the possible results of the operation depending on the input data. An encoding operation therefore consists in applying a random transformation to an elementary operation in order to make this operation illegible. To encode an operation, elements of the truth table can be substituted, by combining the initial table with a random substitution table, in order to obtain an “obfuscated” or “merged” table. Alternatively, a linear transformation can be applied to the operation by combining a vector representing the output data, or a matrix corresponding to the operation, with another matrix, called encoding matrix, the latter also being random. An encoding can also be a combination of one or more substitutions and one or more encoding matrices. Other encoding types are possible. In addition, each elementary operation following an encoded elementary operation is itself combined with an “inverse” encoding, or decoding, corresponding to the inverse of the previous encoding. This is for example the inverse substitution table or the inverse matrix corresponding to the previous encoding, so that the algorithm planned initially is not modified by the successive encodings. In all cases, only the truth tables resulting from these encoding operations merged with the elementary operations, in other words the “obfuscated” or “merged” tables are stored in the software memory implementing the algorithm. Consequently, since the attacker can only access the obfuscated tables, they cannot identify which elementary operation is associated with each table and therefore cannot determine the encryption key used and decrypt the secret data.

These encodings, used to encode an encryption (and/or decryption) algorithm in a non-secure execution platform, for example in a smartphone, are said to be “interna”, since they can make the encryption key used in the white box formed by the algorithm implemented illegible.

However, this white box generally communicates firstly with a remote server and secondly with a third-party application located on the same platform. For example, a server frequently encrypts data and sends the encrypted data to the smartphone, then the white box, in other words the decryption algorithm executed by the smartphone, is used to decrypt the data before these decrypted data are sent, in the same smartphone, to a third-party “final” application, intended to use the decrypted data. However, the final applications are developed by third-party companies, independently of the white boxes. These companies therefore purchase white boxes sold as software libraries containing the encryption and decryption algorithm, and an API (Application Programming Interface) to control the algorithm and use the data output from this algorithm in the final application developed. In this context, the “internal” encodings in the white box do not prevent the decrypted data from circulating, unencoded, between the white box and the final application. Similarly, even if the encryption key used is now very difficult to identify in the white box, due to the internal encodings installed in this white box, the attacker can try to port the code, in other words to export the entire code from the white box to another peripheral to process it therein without having to identify the key.

Consequently, it is known in the state of the art to implement, in addition to these internal encodings, “external” encodings placed at the ends of the complete communication channel between transmission of the data and their use. For example, firstly in the remote server, a first “external” encoding is applied to the last truth table of the server encryption algorithm, whether in the form of a substitution table, an encoding matrix or another form of random encoding, so that the data to be sent to the smartphone are not only encrypted as planned, but also encoded before being sent to the smartphone. Then, at the white-box input, the inverse encoding of the external encoding is applied to the first truth table of the decryption algorithm, before the data are processed using the decryption algorithm of the white box and its internal encodings. The inverse encoding corresponding to the first external encoding is therefore part of the white box. Then, a new random encoding is carried out at the white-box output, by applying this new encoding to the last truth table of the white box. Once again, this second encoding is part of the white box. At output, the data are therefore decrypted, but once again encoded, this time using this new random encoding, before being sent to the final third-party application intended to use them. Lastly, in this third-party application, the external encoding corresponding to the inverse of the encoding applied at end of white box is used to decode the data in the application before they are used by the application.

Using these external encodings placed outside the white box, even when the data are decrypted, they do not circulate “unencoded” outside the white box, they remain encoded, therefore protected from the manipulations of an attacker who would want to intercept them. In addition, the attack consisting in porting the entire code from the white box to another peripheral fails, since in this context, the code of the white box comprises an encoding at its input and an encoding at its output. Without the corresponding inverse encodings, which are located remotely (in the server and in the final application), it is impossible to find the unencoded data. In addition, added to the internal encodings, these external encodings associated with encodings at white-box output and input, make it even more difficult to identify the encryption key of the white box.

Note that all these encodings, both internal and external, are random, in other words they call transformations, substitutions or other manipulations unknown to everyone, so that no attacker can find them.

However, this method comprising internal encodings and external encodings still has at least two disadvantages.

Firstly, as indicated above, the final applications are developed by third-party companies which purchase white boxes and use an API to control them. These companies must therefore themselves integrate in their application the external encoding corresponding, inversely, to the encoding of the white-box output. They must then ensure themselves that this external encoding (also called external decoding) is protected in the final application. Their responsibility regarding security is therefore uncomfortable, frequently forcing them to use an external solution, that is potentially costly, not very reliable and makes the entire data communication channel more complex. In addition, this constraint is a violation of the simplified security principle sold to these companies when purchasing the white box.

Secondly, in the event of a leak of the white box, it is difficult to identify the source of the leak. In particular, there is little point in embedding signatures or identification tokens in the white box, since the attacker will be able to modify or delete them.

### SUMMARY

The invention aims in particular to improve the security of a white-box cryptographic algorithm that has already been encoded. It also aims to identify the source of a possible leak of the algorithm.

The invention therefore relates to a method for generating encoding for a computer-implemented cryptographic algorithm, characterised in that the following steps are implemented:
obtaining at least one characteristic specific to a computer peripheral configured to execute a cryptographic algorithm;
on the basis of the specific characteristic, generating a dependent encoding operation of the peripheral;
associating the generated dependent encoding operation with the cryptographic algorithm.

Thus, the transformation associated with the dependent encoding operation depends on at least one characteristic of the peripheral on which the algorithm is intended to be executed. This dependent encoding operation, also called dependent encoding, can therefore be used to anchor the algorithm on a given peripheral. The data and encryption security is therefore improved. In particular, if this dependent encoding is a decoding of a previous encoding, decoding the data involves generating this dependent encoding using the peripheral, since only this peripheral provides the specific characteristic that can be used to generate the correct decoding. Alternatively, if this dependent encoding aims to encode data, these data can also only be decoded using the peripheral.

In addition, since the dependent encoding depends on the peripheral, it is easier to identify the source of the leak of the algorithm, since only the planned peripheral can be used to correctly decode the data encoded using this dependent encoding and therefore to execute the algorithm. In addition, if the attacker modifies the dependent encoding so that the source of the leak cannot be found, the algorithm no longer operates, thereby making any attack pointless.

Advantageously, to associate the dependent encoding operation with the algorithm, the encoding operation is combined with an elementary cryptographic operation of the algorithm in order to form a single merged operation, so that a data item processed by the merged operation is processed according to the elementary cryptographic operation and simultaneously encoded according to the dependent encoding operation.

Thus, the dependent encoding cannot be distinguished from an elementary operation, in particular an encryption or decryption operation, of the algorithm. An attacker having access to the executable code is therefore unable to identify the operation or the dependent encoding. The operation and the encoding are thus “masked”.

Preferably, the dependent encoding operation is associated with the algorithm before any cryptographic execution of the algorithm on the peripheral, in particular when installing the algorithm on the peripheral, the cryptographic execution corresponding in particular to a data encryption or decryption operation.

Thus, the algorithm includes this dependent encoding even before it is used on the peripheral. In this case, the dependent encoding is therefore identical even if the algorithm is implemented on a peripheral other than that having a dependent encoding. In particular, this encoding could be associated with the algorithm before the latter is implemented on the peripheral, if the peripheral and its specific characteristic are known beforehand.

Alternatively, after installing the algorithm on the peripheral, the following steps are carried out: obtaining the specific characteristic, generating the dependent encoding operation and associating the dependent encoding operation with the algorithm, during a cryptographic execution of the algorithm on the peripheral, the cryptographic execution corresponding in particular to a data encryption or decryption operation.

Thus, in this case, the dependent encoding is on the contrary generated when executing the algorithm. In particular, it must be generated again upon each execution. In this case, the dependent encoding generated can therefore vary depending on the peripheral on which it is generated.

Advantageously, the dependent encoding operation associated before any cryptographic execution being a first dependent encoding operation, the dependent encoding operation generated and associated during the cryptographic execution on the peripheral being a second dependent encoding operation, this second encoding operation is generated so that a data item encoded using the first dependent encoding operation is decoded using the second dependent encoding operation.

In other words, the two previous operations are carried out simultaneously to generate two different but corresponding different encodings: one-generated beforehand and remaining identical regardless of the peripheral on which the algorithm is implemented encodes data, while the other, in this case the dependent decoding-generated upon each execution from the peripheral on which the algorithm is implemented-decodes these data. Thus, the data can only be decoded if the algorithm is implemented on the peripheral on which the encoding and decoding are dependent. If the algorithm is implemented on another peripheral, the dependent encoding will encode the data according to the peripheral on which it is dependent, then the dependent decoding will decode them according to the other peripheral, so the data will not be correctly decoded. The association between a dependent encoding generated beforehand and a dependent decoding generated upon each cryptographic execution therefore allows the white box to be anchored on a particular peripheral.

The operations can be switched, so that the operation generated beforehand is the decoding, and the operation generated upon each execution is the encoding.

Preferably, the elementary cryptographic operation being a first elementary cryptographic operation and the merged operation being a first merged operation, the algorithm also comprising a second elementary cryptographic operation following directly after the first elementary cryptographic operation, the following steps are implemented:
combining, before any cryptographic execution of the algorithm on the peripheral, the first dependent encoding operation with the first elementary cryptographic operation to form the first merged operation;
combining, during the cryptographic execution of the algorithm on the peripheral, the second dependent encoding operation with the second elementary operation, to form a second merged operation, so that, when the data item encoded and processed by the first merged operation is processed by the second merged operation, it is decoded according to the second dependent encoding operation and simultaneously processed according to the second elementary cryptographic operation.

Thus, an attacker having access to the executable code cannot distinguish between the dependent encoding and decoding operations and the elementary operations with which they are respectively combined. These elementary and encoding operations are “masked” in the white box.

Advantageously, the following steps are also implemented:
before the first steps mentioned, generating a third encoding operation, not dependent on the peripheral, and a fourth encoding operation, not dependent on the peripheral and generated so that a data item encoded using the third encoding operation is decoded using the fourth encoding operation,
before any cryptographic execution of the algorithm, combining the third encoding operation with the first merged operation, to form a new first merged operation to simultaneously encode the data item according to the first encoding operation and to the third encoding operation and process the data item according to the first elementary operation;
during the cryptographic execution, combining the fourth encoding operation with the second merged operation, to form a new second merged operation to simultaneously decode the data item according to the second encoding operation and to the fourth encoding operation and process the data item according to the second elementary operation.

Thus, non-dependent, in other words random, conventional encoding (and decoding) operations are added to the dependent encoding (and decoding) operations of the peripheral, and are also merged respectively with the first and second elementary operations of the algorithm. Two merged operations are therefore obtained, one corresponding to a first elementary operation, with dependent encoding and with non-dependent encoding (called third encoding operation), the other corresponding to the second elementary operation, with dependent decoding and with non-dependent decoding (called fourth encoding operation), it being impossible to distinguish between these operations in the merged operations. Adding non-dependent encodings and decoding masks the second elementary operation. In fact, since the dependent decoding (the second dependent encoding operation) is only generated when executing the algorithm, in the absence of the non-dependent encoding, the second elementary operation would be accessible and intelligible for an attacker having the executable code. The merge between the non-dependent decoding and the second elementary operation therefore masks the latter before generating the dependent decoding.

Once again, throughout the description, unless otherwise specified, the terms encoding and decoding could be switched.

Preferably, the first and the second elementary cryptographic operations forming a pair of encoded operations, the steps of generating and combining encodings are repeated for at least one other pair of encoded operations of the algorithm, preferably for several pairs.

Thus, the method concerns more than two elementary cryptographic operations of the algorithm. Potentially, each elementary operation of the algorithm can be concerned by an association with a dependent encoding, but generating a dependent encoding or decoding when executing the algorithm requires resources and time that may make the execution too long. It is therefore advantageous to adapt the number of elementary operations combined with the dependent encodings according to the required degree of security and the resources available in the peripheral.

Advantageously, the cryptographic algorithm is of the “AES” (“ Advanced Encryption Standard”) or “DES” (“Data Encryption Standard”) type.

These algorithms, associated with private keys, include in fact operations that can easily be separated from each other and which will form the elementary cryptographic operations. However, the easier it is to separate an algorithm into simple elementary operations, the easier it is to encode it by associating encodings with these operations, in particular in this case dependent encodings.

Preferably, the characteristic obtained specific to the peripheral is one of the following characteristics or a combination of at least some of the following characteristics:
the MAC (“Media Access Control”) number of the peripheral;
the IMEI (“International Mobile Equipment Identity”) number of the peripheral;
the telephone serial number;
a counter of the number of times a cryptographic algorithm has been installed in the peripheral.

Thus, generating the dependent encoding using another peripheral produces a different encoding, or a decoding that does not correspond, since the specific characteristic is different.

Advantageously, generating the dependent encoding operation of the peripheral comprises a step of hashing the one or more characteristics specific to the peripheral, in order to generate a dependent encoding table of the peripheral or a dependent encoding matrix of the peripheral, at least one of the elements of the table or respectively of the matrix resulting from the hashing.

Thus, the SHA type hashing functions, for example from the SHA-2 family, can be used to generate the dependent encoding on the basis of the one or more specific characteristics.

Preferably, to combine the dependent encoding operation with the elementary cryptographic operation, the terms of a truth table corresponding to the elementary operation are substituted using the substitution table generated, to form a merged table corresponding to the merged operation, or a mathematical operation is carried out between a matrix corresponding to the elementary operation and the dependent encoding matrix generated, to form a merged matrix corresponding to the merged operation.

The invention also provides for a cryptographic method in which at least one data item on a computer peripheral is encrypted or decrypted by a cryptographic algorithm and the data item is encoded by at least one encoding operation associated with the algorithm, in which the encoding operation is dependent on at least one characteristic specific to the peripheral.

Preferably, the encoding operation of this cryptographic method has been associated beforehand with the cryptographic algorithm according to the encoding generation method described above.

The invention also provides for a computer program comprising instructions which, when the program is executed by a computer, instruct the computer to implement the steps of the encoding generation method or of the cryptographic method described above.

The invention also provides for a computer-readable storage medium comprising instructions which, when they are executed by a computer, instruct the computer to implement the steps of the encoding generation method or of the cryptographic method described above.

The invention also provides for a computer peripheral comprising computer processing means adapted to execute a cryptographic algorithm associated with an encoding operation generated according to the method described above.

### BRIEF DESCRIPTION OF THE FIGURES

The invention will be better understood on reading the following description, given solely by way of example and with reference to the accompanying drawings in which:

FIG. 1 is a diagram of a system according to one embodiment of the invention;

FIG. 2 is a detailed diagram of a white box according to the embodiment of FIG. 1;

FIG. 3 is a flowchart according to a first embodiment of the invention;

FIG. 4 is a flowchart according to a second embodiment of the invention;

FIG. 5 is a flowchart according to a third embodiment of the invention including the first and second embodiments.

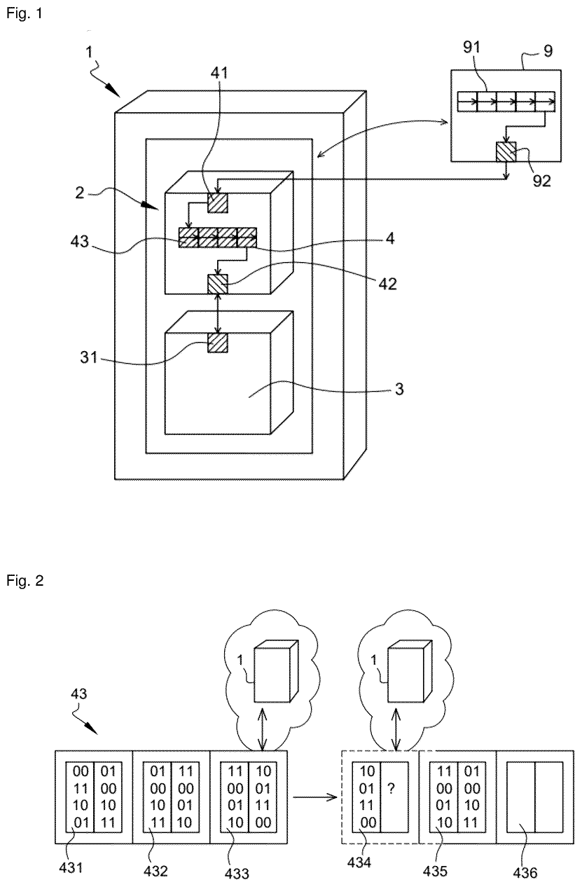

### DETAILED DESCRIPTION

### Definitions

“Elementary operation” designates any transformation, for example mathematical, applied to one or more input data items resulting in one or more output data items of the operation. In an executable code, an elementary operation can thus be represented by a truth table, accessible and intelligible for an informed attacker, indicating, for each possible input of the operation, each corresponding output. It consists in particular in indicating, for any series of input bits in an operation, what is the corresponding series of output bits.

In the remainder of this document, “encoding” will designate any operation intended to make unintelligible, in an executable code, one or more data items or the transformation associated with an elementary operation. The encoding itself is therefore an operation consisting in transforming input data into output data. The encoding of an elementary operation is therefore carried out to prevent an attacker from understanding the truth table of the elementary operation. Such an encoding can therefore consist in replacing the output data of the truth table by other data via a substitution table, not stored and random, indicating the substitutions to be made. It may also consist of a mathematical operation between a value corresponding to the output data of the initial truth table and a random matrix, called encoding matrix, once again not stored. In all cases, the initial truth table can therefore no longer be accessed since it is replaced by the “encoded”, “merged” or “obfuscated” truth table, corresponding to the table resulting from both the elementary operation and the associated encoding operation. The encoded elementary operation and the encoding are therefore combined with each other so that it is no longer possible to distinguish between them when reading the executable code.

For simplicity, although the encoding operation cannot itself be distinguished from the data or the operation with which it is associated, and although it may have been merged with other successive operations, in the remainder of this document, “encoding” can designate the theoretical position of the encoding operation in a series of steps. “Encoding” can also designate the result of an encoding operation.

Note that an inverse encoding, or decoding, necessarily corresponds to any encoding. It is the operation associated with the inverse transformation of the encoding, used to restore the encoded data or operation when it is applied subsequently. In the remainder of the document, the term encoding or inverse encoding can be used indifferently to designate a decoding.

During a series of elementary operations, in particular in an encryption or decryption algorithm, an encoded operation is followed by another operation merged with the inverse encoding. Consequently, the elementary operations follow each other as planned in the algorithm without being disturbed by the encodings. In the executable code, an attacker can manage to identify an obfuscated table corresponding to an elementary operation and to a first encoding, the two operations being merged. Then, the attacker can identify the next obfuscated table corresponding to the inverse encoding, to a new elementary operation and to a second encoding, the three operations also being merged. However, and this is the advantage of the encodings, the attacker is unable to identify the elementary operations carried out since they are merged with the encodings. The attacker is therefore unable to find the encryption key and the encrypted data.

A distinction will be made between encryption/decryption and encoding. Encryption or decryption corresponds to a series of operations carried out using a cryptographic algorithm and a key. Encoding consists in encoding one of these operations or output data of these operations. Thus, “cryptographic algorithm” designates an encryption or decryption algorithm based on a known type of algorithm, for example “DES” or “AES”, using a specific key, and it is different from the encoded operations merged with it.

Lastly, “peripheral” designates any terminal comprising means used to implement the method described. In the remainder of the document, it refers in particular to any communication terminal provided with computer processing means, such as a smartphone.

### Embodiment

In the embodiment shown, the invention is implemented in a smartphone 1. The latter includes, as software, a final application whose executable code 2 is shown diagrammatically. This application receives as input encrypted data, such as data transmitted by a remote bank server 9, and generates as output a payment by smartphone. It could be any other type of application and any other type of data. In all cases, it consists of a code 2 executable by the smartphone 1, code 2 that can be diagrammatically divided into two parts.

Thus, the part 3 results directly from the source code developed by the developer, or development company, responsible for the application 2. It is not specific to the invention but it is the core of the application 2 since it receives as input the decrypted data and implements the role assigned to the application, in this case a payment according to methods which are not specific to the invention and will not be described.

The part 4 of the code 2 comprises a cryptographic algorithm of the “AES” (“ Advanced Encryption Standard”) type operating with a private key and encodings internal to the algorithm which will be described below. These operations form a decryption method 43, used to decrypt the data received from the server 9 before sending them to the part 3 which will use them. This part 4 could also be used to encrypt data to be sent to the server, in this case we would speak of encryption. The part 4 forms a “white box”. In fact, an attacker having the smartphone 1 can read the entire code 2 of the application, manipulate it, execute it precisely, to try to identify in this part 4 the encrypted data, and/or the elementary operations forming the encryption or decryption algorithm 42 to deduce in particular the key used. The attacker can also try to export this white box 4 to another device.

This white box 4 also contains two encodings 41 and 42, different from the encodings internal to the algorithm 43 which will be described below. “External” encodings 92 and 31 correspond to these encodings 41 and 42. The encoding 42 is used to encode the data output from the decryption operations of the algorithm 43. Thus, although the data is decrypted by the algorithm 43, they do not circulate “unencoded” between the white box 4 and the core 3. The core 3 of the application comprises at its input an encoding 31 which is the inverse encoding of the encoding 42, used to decode the data received from the white box 4. This inverse encoding 31 is merged with the first operation programmed by the core 3 so that this encoding 31 is unintelligible. The encoding 31 is considered to be “external” since it is outside the white box. However, it can only decode the data encoded by the encoding 42 of the white box, and vice versa. Similarly, the encoding 41 at the input of the white box 4 is the inverse encoding of the encoding 92 placed at output of the algorithm 91 in the server 9. Thus, the data output from the server 9 are both encrypted and encoded, before being decoded by the encoding 41 then decrypted by the algorithm 43. Note that the encoding 92 is the only encoding associated with the algorithm 91. In particular, this algorithm 91 does not include internal encodings, associated with elementary operations.

The part 4, including the algorithm 43 and the internal encodings 41 and 42, is not developed directly by the developer of the application 2. In fact, it was developed by another company independently of part 3, and was purchased by the developer of the application 2 to be implemented as software libraries. Thus, to control this independent white box 4, the code of the part 3 comprises calls to an API (“Application Programming Interface”) supplied by the vendor of the white box 4, the API being used for example to initialise the algorithm, encrypt or decrypt data using this algorithm 43. The developer therefore used the API to program the calls to the white box 4 in order to obtain the decrypted data or, on the contrary, supply data to be encrypted to the white box 4.

Lastly, remotely from the smartphone, the bank server 9 also includes as software an “AES” algorithm and an associated private key. The algorithm can be used to encrypt data using the key before sending them to the smartphone 1. These encryption operations form the encryption algorithm 91. It can also be used to decrypt data received. However, and unlike the algorithm 43, this algorithm 91 does not comprise internal encodings.

We will now detail the operations of the cryptographic algorithm 43 placed in the white box 4 and executed in the smartphone 1, referring to FIG. 2. We will not describe to what extent and when the private key is changed, nor how it is communicated to the server 9, since these elements are not specific to the invention.

Combining an AES type algorithm and a private key produces the cryptographic algorithm 43 which is used in the embodiment shown to decrypt the data encrypted by the algorithm 91. It therefore consists of a series of elementary operations resulting from the combination between the AES algorithm as it is known and the private key chosen or determined. These operations are encoded, in other words an encoding is associated with each operation.

The encodings 432 and 435 do not depend on the characteristics of the smartphone 1, they are generated when installing the application 2 on the smartphone independently of the smartphone, or even before it is installed. Similarly, the encodings 41 and 42 do not depend on the smartphone 1. However, they are chosen so that they correspond to the inverses of the respective external encodings 92 and 31, or vice versa.

These encodings 432, 435, 41, 42, 92 and 31 are therefore generated in the usual way.

However, the encoding 433, generated when installing the application 2 on the smartphone 1, depends directly on the smartphone 1, while the encoding 434 is only generated each time the algorithm 43 is executed and also depends on the smartphone 1, as described below.

On FIG. 2, the elementary operation 431 is encoded by the encoding 432. This encoding 432 is conventional: it is the application of a randomly chosen substitution table. Thus, the substitutions made depend on nothing but chance. A new encoding, the encoding 433, is then applied. It is a different type of encoding: it was not chosen by chance. On the contrary, the substitution table of this encoding 433 was chosen when installing the application 2 on the smartphone 1 and was created using the characteristics of the smartphone 1, according to a method which will be described below. In other words, this encoding 433 depends directly on the smartphone 1 on which the application 2 will be used.

The operation 431, the encoding 432 and the encoding 433 are merged so that they can no longer be distinguished from each other, and the corresponding truth table is permanently implemented in the algorithm 43 as soon as the application 2 has been installed on the smartphone 1. The initial elementary operation 431 can now no longer be identified as such by an attacker. The next elementary operation of the algorithm 43 is the operation 436. It is merged with the encoding 435 which is the inverse encoding of the encoding 432. These two operations must also be merged with the inverse encoding 434 of the encoding 433. By construction, this inverse encoding 434 also necessarily depends on the smartphone 1. However, unlike all the previous encodings, the encoding 434 is not implemented in the application 2, either before or after its installation. In fact, it is only generated when these operations are executed.

### Encoding Generating Method

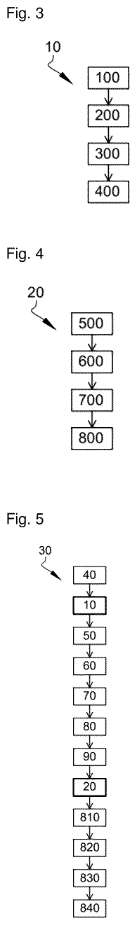

We will now describe, referring to FIG. 3, an encoding generation method 10 to generate the dependent encoding 433. It is implemented when installing the application 2 in the smartphone 1.

Note that the elementary operations with which the encodings are combined concern data forming eight-bit vectors, in other words 256 possible inputs. Obviously, this number can vary and be adjusted so that the resources available correspond to the required level of security.

In step 100, the program 2 requests characteristics specific to the smartphone 1, in other words the MAC (“Media Access Control”) number, the IMEI (“International Mobile Equipment Identity”) number, and the telephone serial number. It also generates a fourth number which is a counter incremented each time the white box 4 is installed on the smartphone 1. The term “fingerprints” is used to designate these characteristics specific to the smartphone 1. These calls are made by the code 2 using conventional APIs associated with the smartphone. These calls may have been authorised beforehand by the user when confirming the installation of the application 2. The specific characteristics may have been chosen differently.

In step 200, the fingerprints obtained are provided to a SHA256 type hashing function, the hashing function having been chosen so that the output corresponds to a substitution table of the same type as the truth table of the conventional encodings. The hashing function is also chosen so that a variation of one of the numbers supplied generates a different substitution table as output. Lastly, it is chosen so that this table can only be obtained by the hashing of the input numbers and not by other numbers. Thus, this table, which therefore corresponds to a dependent encoding of the smartphone 1, can only have been generated by the smartphone 1. This internal encoding is therefore used to anchor the white box on the smartphone 1. If the hashing function is used to establish a dependent encoding matrix, this matrix must be invertible, so that the inverse encoding can be determined.

In step 300, the dependent substitution table, or dependent encoding table, is applied to the truth table resulting from the encoding 432 (itself applied to the initial table 431).

In step 400, only the final truth table, resulting from the combination between the table associated with the initial operation 431, the encoding 432 and the dependent encoding 433, is stored in the executable code 2.

Note that, instead of obtaining the characteristics directly from the peripheral 1 in step 100, they may be known beforehand. In this case, steps 200 to 400 could be carried out outside the peripheral 1. The encoding 433 could thus be placed in the algorithm before installing this algorithm in the peripheral 1.

We will now describe, referring to FIG. 4, an encoding generation method 20 to generate the dependent encoding 434. It is only implemented each time the algorithm 43 is executed on the peripheral 1, in other words when decrypting data.

In step 500, which is the first step of generating this encoding 434, the program 2 requests the characteristics specific to the smartphone 1, in other words the MAC (“Media Access Control)” number, the IMEI (“International Mobile Equipment Identity”) number, and the telephone serial number. It also generates the counter starting at 0. Since these calls are made on the same smartphone 1 as that on which the calls of step 100 were made, and since the counter is chosen to start at the same point, the same fingerprints are obtained.

In step 600, the same hashing function as that of step 200 is applied to these numbers. This results in the same substitution table as that determined in step 200 of the method 10.

In step 700, this table is inverted, inputs and outputs replacing each other. This table is therefore the inverse of the table resulting from step 200. Data encoded using one of the tables could therefore be decoded directly by the other table.

In step 800, this inverse table is merged with the encoding 435 and the table associated with the new elementary operation, 436, so that a single table corresponding to these three operations is stored in the software implementation.

The data resulting from the operation 431 and encoded by the internal encodings 432 and 433 can now be decoded by the internal decodings 434 and 435 at the same time as the elementary operation 436 is carried out.

Obviously, the roles of the encodings 433 and 434 can be switched by generating the inverse encoding 434 during installation and the encoding 433 only upon each decryption operation.

Note that, in this embodiment, only the operations 431 and 436 are associated with dependent encodings 433 and 434. The other elementary operations of the algorithm 43 are only associated with conventional encodings, such as the encodings 432 and 435, which do not depend on the smartphone 1 and are not generated when executing the decryption, but implemented during installation (or even before). However, it may be advantageous to carry out dependent encodings for several operations of the algorithm 43, to further improve the security of the method. However, it may not be necessary to carry out dependent encodings for all the elementary operations. In fact, too many generations of dependent encodings could result in excessive consumption of resources during the decryption operation, since each encoding to be generated in this context must undergo steps 500 to 800. The time spent executing the algorithm 43 is also likely to be increased.

Finally, in a variant with several dependent encodings, each operation of the algorithm 43 is associated with a conventional encoding, then some of these operations are, in addition, associated with dependent encodings such as the encodings 433 and 434. The developer of the white box is responsible for identifying the number and positions of the dependent encodings depending on the required degree of security and on the resources of the planned peripheral.

### Data Encryption, Decryption, Encoding and Decoding

We will now describe a method 30 summarising the data communication chain between the server 9 and the core 3 of the application 2 using in particular the methods 10 and 20.

Step 40 is the initialisation of the communication channel. The white boxes 4 and 91, respectively in the smartphone 1 and the server 9, are installed when the application 2 is installed. The initial elementary operations of the algorithm 43, as well as the algorithm 91, are generated so that the algorithm 43 can decrypt the data encrypted by the algorithm 91, and vice versa. In particular, for an “AES” type algorithm, the private key is the same for the algorithms 43 and 91. The algorithms differ, however, in that the algorithm 91, placed on the server, does not comprise any internal encodings, since the server is considered to be a secure environment.

Steps 100 to 400 of the method 10 are then implemented. In particular, the dependent encoding 433 is generated at this point in the application 2 using the characteristics of the smartphone 1. This is also the case for the non-dependent encodings 432 and 435.

In step 50, the core 3 of the application 2 involves the transmission of secret data by the remote server 9. These data consist in particular of validations of banking data to validate a payment.

In step 60, the server 9 encrypts the requested data using the algorithm 91.

In step 70, the encrypted data are encoded by the external encoding 92 located on the server 9.

In step 80, they are sent to the smartphone 1, in particular to the application 2, and in particular to the white box 4.

In step 90, the encoding 41 at the input of the white box, which corresponds to the inverse of the encoding 92, decodes the data. As a reminder, since this decoding is merged with the next operation and encoding, it is unintelligible for an attacker.

Steps 500 to 800 described above, of the method 20, are then carried out on the core of the data decryption algorithm 43. In particular, the dependent encoding 434, inverse of the encoding 433, is only generated during this decryption.

In step 810, once the encoding 433 has been generated, the data are decrypted and decoded.

In step 820, the data that are still decrypted are encoded again, this time using the encoding 42.

In step 830, the decrypted and encoded data are sent to the core 3 of the application.

In step 840, the external encoding 31, inverse of the encoding 42, decodes the data. Once again, since it is merged with the subsequent operations of the core 3, it cannot be identified.

Note that although the method shown is a decryption method, the encodings operate in the same way as for an encryption method. In this case, the encodings are associated with elementary encryption, rather than decryption, operations.

The dependent internal encodings 433 and 434 are therefore used to anchor the white box on the smartphone 1. Thus, even if an external encoding, typically the encoding 31, should leak, in other words be identified by an attacker, the dependent encodings internal to the white box would provide additional security. In fact, due to these dependent encodings 433 and 434, the smartphone 1 is required to execute the algorithm. In fact, by executing it on a different device, the encoding 434 generated during execution on this new peripheral would not correspond to the dependent encoding 433 of the smartphone 1, and the entire algorithm 43 would fail.

An attacker is therefore unable to operate the white box on another device. In addition, unlike a signature or identification token, these dependent encodings cannot be deleted by the attacker since, being merged with the elementary steps of the algorithm, they are an integral part of the algorithm and any modification would cause the execution of the algorithm to fail.

An attack is therefore only possible using a virtual machine aimed at falsifying the fingerprints of the peripheral. However, to do this, a thorough knowledge of the peripheral is required, to such an extent that it is preferable to own it, making it pointless to create

This method of dependent encodings internal to the white box depends on the developer of the white box and not on the developer of the final application. This is in line with the spirit of simplified security associated with the sale of “turnkey” white boxes to companies developing final applications. In particular, the responsibility of these companies concerning the protection of the external encodings is reduced since the dependent encodings internal to the white box offer additional security.

In addition, generating a dependent encoding makes it easier to identify a leak. In fact, since only the execution platform suitable for the dependent encoding can be used to execute the algorithm, it is easier to identifier the platform where the leak comes from. Thus, in the embodiment shown, if the white box 4 should leak, it would not operate on any device except the smartphone 1, and it would then be possible to determine that the leak comes from the smartphone 1.

The invention is not limited to the embodiments described and other embodiments will be clearly apparent to those skilled in the art.

For example, other hashing functions are possible. In addition, the specific characteristic is not limited to the examples provided but concerns any characteristic that can be extracted from a peripheral and which is specific to this peripheral. It also concerns any relevant combination of specific characteristics used to isolate one peripheral even more from the others.

In addition, the invention makes particularly relevant the fact that the external encodings, which in the embodiment shown are the encodings 92 and 31, are not required. In this case, the encodings 41 et 42 are also removed. This is particularly relevant as regards the external encoding 31 whose implementation and protection must be provided by the developer of the final application 2, which is a violation of the simplified security principle sold with the white box 4. However, since the dependent encodings are used to anchor the white box on the peripheral like the external encodings, the latter become redundant and can be deleted. In this case, any attack such as porting the code of the white box remains difficult due to the dependent encodings, and the developer of the final application is no longer responsible for the security of an encoding. In this case, however, the data circulate unencoded, in other words decrypted, between the decryption algorithm and the final application.

Internal encodings can be integrated in the algorithm 91 in order to improve its security. In addition, as in the white box 43, dependent encodings can be integrated in the algorithm 91 of the server, to further improve its security and make it easier to identify a possible leak from this white box 91. However, this is generally not as essential as for an algorithm operating on a mobile peripheral, where security is less reliable.

Dependent encodings can be integrated in cryptographic algorithms other than of the AES type. This is for example the case for the DES (“Data Encryption Standard”) algorithm. More generally, the dependent encodings of the invention can be applied to any algorithm that can be encoded. This is particularly the case of encryption or decryption methods divided into elementary operations that can be encoded.

1. An encoding generation method for a computer-implemented cryptographic algorithm, characterised in that the following steps are implemented:
obtaining at least one characteristic specific to a computer peripheral configured to execute a cryptographic algorithm;
on a basis of the specific characteristic, generating a dependent encoding operation of the peripheral;
associating the generated dependent encoding operation with the cryptographic algorithm.

2. The method according to claim 1, wherein, to associate the dependent encoding operation with the algorithm, the encoding operation is combined with an elementary cryptographic operation of the algorithm in order to form a single merged operation, so that a data item processed by the merged operation is processed according to the elementary cryptographic operation and simultaneously encoded according to the dependent encoding operation.

3. The method according to claim 1, wherein the dependent encoding operation is associated with the algorithm before any cryptographic execution of the algorithm on the peripheral, when installing the algorithm on the peripheral, the cryptographic execution corresponding to a data encryption or decryption operation.

4. The method according to claim 1, wherein, after installing the algorithm on the peripheral, the following steps are carried out: obtaining the specific characteristic, generating the dependent encoding operation and associating the dependent encoding operation with the algorithm, during a cryptographic execution of the algorithm on the peripheral, the cryptographic execution corresponding to a data encryption or decryption operation.

5. The method according to claim 3, wherein, after installing the algorithm on the peripheral, the following steps are carried out: obtaining the specific characteristic, generating the dependent encoding operation and associating the dependent encoding operation with the algorithm, during a cryptographic execution of the algorithm on the peripheral, the cryptographic execution corresponding to the data encryption or decryption operation, and wherein the dependent encoding operation associated before any cryptographic execution being a first dependent encoding operation, the dependent encoding operation generated and associated during the cryptographic execution on the peripheral being a second dependent execution operation, this second encoding operation is generated so that a data item encoded using the first dependent encoding operation is decoded using the second dependent encoding operation.

6. The method according to the claim 5, wherein, to associate the dependent encoding operation with the algorithm, the encoding operation is combined with an elementary cryptographic operation of the algorithm in order to form a single merged operation, so that a data item processed by the merged operation is processed according to the elementary cryptographic operation and simultaneously encoded according to the dependent encoding operation, and wherein the elementary cryptographic operation being a first elementary cryptographic operation and the merged operation being a first merged operation, the algorithm also comprising a second elementary cryptographic operation following directly after the first elementary cryptographic operation, the following steps are implemented:
combining, before any cryptographic execution of the algorithm on the peripheral, the first dependent encoding operation with the first elementary cryptographic operation to form the first merged operation;
combining, during the cryptographic execution of the algorithm on the peripheral, the second dependent encoding operation with the second elementary operation, to form a second merged operation, so that, when the data item encoded and processed by the first merged operation is processed by the second merged operation, it is decoded according to the second dependent encoding operation and simultaneously processed according to the second elementary cryptographic operation.

7. The method according to claim 6, wherein the following steps are also implemented:
before the steps of obtaining the at least one characteristic specific to a computer peripheral, generating the dependent encoding operation of the peripheral, and associating the generated dependent encoding operation with the cryptographic algorithm, a step of generating a third encoding operation, not dependent on the peripheral, and a fourth encoding operation, not dependent on the peripheral and generated so that a data item encoded using the third encoding operation is decoded using the fourth encoding operation,
before any cryptographic execution of the algorithm, combining the third encoding operation with the first merged operation, to form a new first merged operation to simultaneously encode the data item according to the first encoding operation and to the third encoding operation and process the data item according to the first elementary operation;
during the cryptographic execution, combining the fourth encoding operation with the second merged operation, to form a new second merged operation to simultaneously decode the data item according to the second encoding operation and to the fourth encoding operation and process the data item according to the second elementary operation.

8. The method according to claim 6, wherein, the first and the second elementary cryptographic operations forming a pair of encoded operations, the steps of generating and combining encodings are repeated for at least one other pair of encoded operations of the algorithm.

9. The method according to claim 1, wherein the cryptographic algorithm is of an “AES” (“Advanced Encryption Standard”) or “DES” (“Data Encryption Standard”) type.

10. The method according to claim 1, wherein the characteristic obtained specific to the peripheral is one of the following characteristics or a combination of at least some of the following characteristics:
a MAC (“Media Access Control”) number of the peripheral;
an IMEI (“International Mobile Equipment Identity”) number of the peripheral;
a telephone serial number;
a counter of a number of times a cryptographic algorithm has been installed in the peripheral.

11. The method according to claim 1, wherein generating the dependent encoding operation of the peripheral comprises a step of hashing one or more characteristics specific to the peripheral, in order to generate a dependent encoding table of the peripheral or a dependent encoding matrix of the peripheral, with at least one element of the table or respectively of the dependent encoding matrix resulting from the hashing.

12. The method according to claim 11, wherein, to associate the dependent encoding operation with the algorithm, the encoding operation is combined with an elementary cryptographic operation of the algorithm in order to form a single merged operation, so that a data item processed by the merged operation is processed according to the elementary cryptographic operation and simultaneously encoded according to the dependent encoding operation, and wherein, to combine the dependent encoding operation with the elementary cryptographic operation, terms of a truth table corresponding to the elementary operation are substituted using the substitution table generated, to form a merged table corresponding to the merged operation, or a mathematical operation is carried out between a matrix corresponding to the elementary operation and the dependent encoding matrix generated, to form a merged matrix corresponding to the merged operation.

13. A cryptographic method, wherein at least one data item on a computer peripheral is encrypted or decrypted by a cryptographic algorithm and the data item is encoded by at least one encoding operation associated with the algorithm, characterised in that the encoding operation is dependent on at least one characteristic specific to the peripheral.

14. The method according to claim 13, wherein the encoding operation has been associated beforehand with the cryptographic algorithm by obtaining at least one characteristic specific to a computer peripheral configured to execute a cryptographic algorithm, generating a dependent encoding operation of the peripheral on a basis of the specific characteristic, and associating the generated dependent encoding operation with the cryptographic algorithm.

15. computer program, comprising instructions which, when the program is executed by a computer, instruct the computer to implement the steps of the method according to claim 1.

16. A non-transitory computer-readable storage medium, comprising instructions which, when they are executed by a computer, instruct the computer to implement the steps of the method according to claim 1.

17. A computer peripheral comprising computer processing means adapted to execute the cryptographic algorithm associated with an encoding operation generated according to claim 1.
